(19) United States
(12) Patent Application Publication
(10) Pub. No.: US 2010/0309882 A1
(43) Pub. Date: Dec. 9, 2010

(54) HANDOVER METHOD FOR MOBILE WIRELESS NETWORK

(75) Inventors: Nam-Kyung Lee, Daejon (KR); Dong-Jun Lee, Seoul (KR); Myunghee Han, Gyeonggi-do (KR); Hokyom Kim, Daejon (KR)

Correspondence Address: LAHIVE & COCKFIELD, LLP;FLOOR 30, SUITE 3000, ONE POST OFFICE SQUARE, BOSTON, MA, 02109, US

(73) Assignee: ELECTRONICS AND TELECOMMUNICATIONS RESEARCH INSTITUTE, Daejon (KR)

(21) Appl. No.: 12/808,997

(22) PCT Filed: Jul. 10, 2008
(86) PCT No.: PCT/KR2008/004069

§ 371 Date: Jun. 17, 2010

(30) Foreign Application Priority Data
Dec. 17, 2007 (KR) 10-2007-0132495

(51) Int. Cl. H04W 36/00

(52) U.S. Cl. 370/331

(57) ABSTRACT

Provided is a handover method for a mobile wireless network. The handover method for a mobile wireless network, including: receiving, by a mobile node, information on a new access router by requesting the information necessary for the handover from a previous access router in accordance with a handover initiation; sending a fast binding update message to the previous access router via the new access router by connecting to the new access router; receiving a packet from the new access router; and disconnecting from the previous access router.

### TECHNICAL FIELD

The present invention relates to a handover method for a mobile wireless network; and, more particularly, to a handover method capable of providing a seamless service between a satellite network and a terrestrial wireless network.

This work was supported by the Communications, Ocean and Meteorological Satellite program of MIC/IITA [2007-S-301, “Development of Satellite Communications System for Communications, Ocean and Meteorological Satellite”].

### BACKGROUND ART

Network mobility is to provide a seamless Internet connection to all mobile terminals or nodes connected to the network.

A mobile node performs a handover in two layers when it moves from one wireless cell to another neighbor wireless cell. In general, a handover for moving a wireless access point in a layer 2, i.e., a link layer, is followed by a binding update (BU) process of establishing a temporary address to be used at a new cell in a layer 3, i.e., an IP layer, and notifying a correspondent node (CN) and its own home network of the temporary address.

Although the handover in the layer 3 is performed in a relatively short period of time, the handover in the layer 3 may take several seconds. During the handovers, a mobile node cannot transmit/receive a packet. This makes the mobile node temporarily invisible, which is referred to as a latency.

A long latency may cause a fatal defect in a real-time data traffic such as a multimedia streaming which is sensitive to the latency. Moreover, a mobile network requires two or more paths to support a normal service, in spite of an unstable wireless link in the mobile network.

FIG. 1 is a flowchart illustrating a general handover method.

Referring to FIG. 1, an MN in a mobile IPv6 has two addresses for identifying itself to ensure its mobility. One is a unique address fixed in an MN as a home address. When a correspondent node (CN) communicating with the MN transmits a packet to a unique home address of the MN in a fixed network, a router home agent in a home network instead transmits the packet to a location where the MN is actually connected. At this point, the actual location of the MN is required. The location is represented by the other address, a care-of-address (CoA). The CoA varies while the MN moves.

In a mobile IPv6, a CoA is generated by a stateless address autoconfiguration. A 128-bit CoA may be simply generated by combining a 64-bit network prefix and a 64-bit network identifier.

A handover of a layer 2 is performed when an MN moves beyond a range of a wireless cell which one access router (AR) takes charge of. That is, a layer 2 connection is changed to another wireless cell. However, the movement of the MN is not detected in an IP layer, though the MN falls within a range of another network. The MN cannot detect its own movement before receiving a router advertisement (RA) message a new access router (NAR) broadcasts to cell nodes within the jurisdiction of the NAR. The MN detects its movement to another network based on subnet prefix information of the NAR included in the RA message. The moving node generates a CoA using the subnet prefix to ensure an access point in the new network.

As described above, since the CoA automatically varies in accordance with the movement location of the MN, it is necessary to notify a home agent and an AR of the new CoA to continuously receive a packet to be inputted into the previous CoA after the movement of the MN. Accordingly, the MN sends a binding update (BU) message to the home agent and the AR whenever performing a handover, also periodically. The home agent forwards the received packets to a home address of the MN by tunneling them through the AR.

A previous access router (PAR) also forwards the packets transmitted to the previous CoA to the MN by tunneling the packets through the NAR while not detecting the movement of the MN. The MN receiving the forwarded packets performs a BU with respect to a CN. From that time, the CN sends a packet to the CoA of the MN.

As described above, the long handover latency occurs until the MN actually transmits/receives the packets to the new CoA after the handover is performed in the layer 2. In conventional handover scheme, the MN cannot receive further packets out of a cell range of the PAR. Moreover, the MN cannot establish the new CoA until the movement of the MN to the NAR is detected by a reception of the RA message. This makes the handover latency longer.

FIG. 2 is a time-line diagram illustrating a handover method. A link switching latency 210 represents a handover in a layer 2. An IP connectivity latency 220 represents an elapsed time between a movement detection and an address establishment, which corresponds to an elapsed time from a time when an MN is disconnected from a PAR beyond a range of the PAR to a time when the MN receives an advertisement message from the NAR after connection to the NAR. If the MN receives the advertisement message by performing a layer 2 handover at the time when the NAR broadcasts the advertisement message, the IP connectivity latency 220 may be shortened. In the worst case when the handover is performed at the immediate time after the RA message is broadcast, a waiting time until next RA message becomes long.

A packet reception latency 230 is an elapsed time between a binding update of the new CoA and a reception of a response. The MN cannot receive packets over the new CoA during the packet reception latency 230. The packet reception latency 230 varies with a congestion state of the network to which BU/BACK messages are transmitted.

As described above, the conventional mobile IPv6 handover causes a long latency including a time for detecting the movement of the MN, a time for establishing the address, and a time for transmitting the BU/BACK messages. Thus, packet loss and latency seriously affect a real-time service such as a multimedia streaming service.

One of methods that can solve the above-described problems is a fast handover scheme using a trigger.

In the fast handover scheme, an MN initiates a handover based on a trigger generated at a layer 2, requests information necessary for the handover to a PAR, and receives a subnet prefix with respect to an NAR.

A MN requests a fast binding update (FBU) to the PAR, and the PAR transmits a response to the binding update to the MN and the NAR. Accordingly, packets are forwarded from the PAR to the NAR.

The MN notifies the NAR that the MN is moved. To response this notification, the NAR transmits an advertisement message and packets to the MN.

However, the conventional fast handover scheme sends a FBU to the PAR before the MN completes an access to the NAR. This may cause the NAR not to prepare itself to send data to the MN though the PAR forwards packets to the NAR. This may cause a long transmission latency, which results in a communication disconnection in a handover between a satellite network and a terrestrial wireless network.

### DISCLOSURE OF INVENTION

### Technical Problem

An embodiment of the present invention is directed to providing a handover method for a mobile wireless network, which is capable of minimizing a handover latency and providing a seamless service by maintaining a layer 2 connection to a PAR and an NAR until an MN receives data and sending a fast binding update to the NAR after completing a connection to the NAR.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a handover method for a mobile wireless network, including: receiving, by a mobile node, information on a new access router by requesting the information necessary for the handover from a previous access router in accordance with a handover initiation; sending a fast binding update message to the previous access router via the new access router by connecting to the new access router; receiving a packet from the new access router; and disconnecting from the previous access router.

In accordance with another aspect of the present invention, there is provided a handover method for a mobile wireless network, including: receiving a message requesting information necessary for a handover from a mobile node in accordance with a handover initiation of the mobile node; sending information on a new access router to the mobile node; sending a fast binding update message received from the mobile node to a previous access router after completing a connection to the mobile node; sending a packet forwarded from the previous access router to the mobile node; and disconnecting from the mobile node by the previous access router.

### ADVANTAGEOUS EFFECTS

A handover method for a mobile wireless network in accordance with an embodiment of the present invention can minimize a handover latency and provide a seamless service by maintaining a layer 2 connection to a PAR and an NAR until an MN receives data and sending a fast binding update to the NAR after completing a connection to the NAR.

### BRIEF DESCRIPTION OF THE DRAWINGS

FIG. 1 is a flowchart illustrating a conventional handover method.

FIG. 2 is a time-line diagram illustrating a conventional handover method.

FIG. 3 is a flowchart illustrating a handover method in accordance with an embodiment of the present invention.

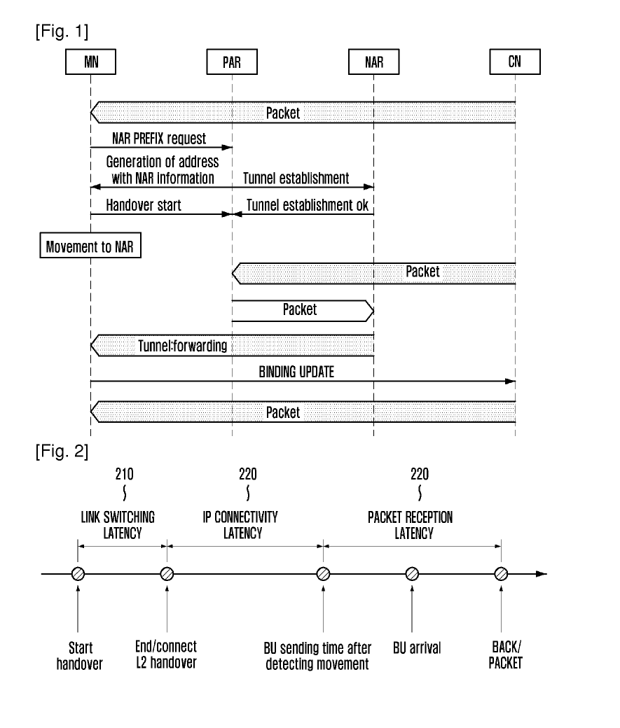

### BEST MODE FOR CARRYING OUT THE INVENTION

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

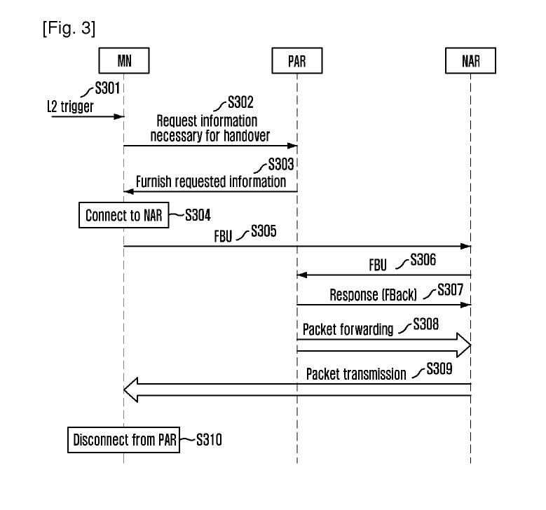

FIG. 3 is a flowchart illustrating a handover method for a mobile wireless network in accordance with an embodiment of the present invention.

In operation S301, a handover is initiated by a layer 2 (L2) trigger. A current fast handover allows the trigger to initiate the handover. The trigger is information from the layer 2, which is to notify a layer 3 (L3) of information on an event occurring in the layer 2. A start point of the handover is determined by the trigger. The trigger is generated in expectation of a handover when the strength of a received radio wave becomes smaller than a specific critical value. In addition, the generation of the trigger initiating the handover may depend on factors such as cost or bandwidth variation. In either case, the trigger instructing the initiation of the handover is generated prior to disconnection of the layer 2. Since an AR cannot know the strength of radio wave an MN receives, the handover determined from the strength of the radio wave is initiated only by the MN.

When the MN receives the layer 2 trigger, the MN sends a router solicitation for proxy (RtSolPr) message requesting information necessary for the handover to a PAR in operation S302. The information necessary for the handover includes, for example, a subnet prefix of an NAR. The MN may selectively involve its own link layer address (if Ethernet, 48 bits of Ethernet address) in the RtSolPr message.

In IPv6, all ARs exchange data with neighbor routers through a neighbor discovery. In operation S303, the PAR transmits a proxy router advertisement (PrRtAdv) message to the MN. The PrRtAdv message includes the subnet prefix of the NAR.

In operation S304, the MN establishes a connection between the NAR and the layer 2, based on the subnet prefix of the NAR. In operation S305, the MN sends a fast binding update (FBU) message to the NAR. In operation S306, the NAR sends the FBU message the PAR.

In operation S307, the PAR sends a fast binding acknowledgment (FBACK) message in response to the FBU message to NAR. In operation S308, the PAR forwards a packet to be sent to the MN to the NAR. In operation S309, the NAR sends the packet to the MN.

In operation S310, the MN releases a layer 2 connection with the PAR. The PAR sends a handover completion message to the MN, so that the layer 2 connection may be released.

The method of the present invention may be programmed in a computer language. Codes and code segments constituting the computer program may be easily inferred by a computer programmer skilled in the art. Furthermore, the computer program may be stored in a computer-readable recording medium including all kinds of media such as CD-ROM, RAM, ROM, floppy disk, hard disk and magneto-optical disk, and read and executed by a computer to embody the methods.

The present application contains subject matter related to Korean Patent Application No. 2007-0132495, filed in the Korean Intellectual Property Office on Dec. 17, 2007, the entire contents of which are incorporated herein by reference.

While the present invention has been described with respect to the specific embodiments, it will be apparent to those skilled in the art that various changes and modifications may be made without departing from the spirit and scope of the invention as defined in the following claims.

1. A handover method for a mobile wireless network, comprising:
receiving, by a mobile node, information on a new access router by requesting the information necessary for the handover from a previous access router in accordance with a handover initiation;
sending a fast binding update message to the previous access router via the new access router by connecting to the new access router;
receiving a packet from the new access router; and
disconnecting from the previous access router.

2. The handover method of claim 1, wherein the handover initiation is performed by a layer 2 trigger.

3. The handover method of claim 1, wherein the information on the new access router comprises a subnet prefix information of the new access router.

4. The handover method of claim 3, wherein said sending of the fast binding update message comprises sending the fast binding update message to the new access router after performing a layer 2 connection to the new access router.

5. The handover method of claim 2, wherein the layer 2 trigger is generated when strength of radio wave, which the mobile node receives, is smaller than a reference critical value determining the handover initiation.

6. The handover method of claim 1, wherein the mobile node is disconnected from the previous access router at a time when receiving the packet from the new access router.

7. The handover method of claim 1, wherein the mobile node is disconnected from the previous access router when the mobile node receives the packet and a handover completion message from the new access router and the previous access router, respectively.

8. A handover method for a mobile wireless network, comprising:
receiving a message requesting information necessary for a handover from a mobile node in accordance with a handover initiation of the mobile node;
sending information on a new access router to the mobile node;
sending a fast binding update message received from the mobile node to a previous access router after completing a connection to the mobile node;
sending a packet forwarded from the previous access router to the mobile node; and
disconnecting from the mobile node by the previous access router.

9. The handover method of claim 8, further comprising receiving the packet to be forwarded after receiving a response to the fast binding update message from the previous access router in accordance with the sending of a fast binding update message.

10. The handover method of claim 8, wherein the handover initiation is performed by a layer 2 trigger.

11. The handover method of claim 8, wherein the information on the new access router comprises a subnet prefix information of the new access router.

12. The handover method of claim 11, wherein said sending of the fast binding update message is performed after completing a layer 2 connection to the mobile node.

13. The handover method of claim 8, wherein the mobile node is disconnected from the previous access router at a time when receiving the packet from the new access router.

14. The handover method of claim 8, wherein the mobile node is disconnected by a handover completion message which the previous access router sends to the mobile node.
